(19) United States
(12) Patent Application Publication
(10) Pub. No.: US 2008/0068276 A1
(43) Pub. Date: Mar. 20, 2008

(54) ANTENNA DEVICE

(76) Inventor: Junichi Noro, Akita (JP)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/844,730

(22) Filed: Aug. 24, 2007

(30) Foreign Application Priority Data
Sep. 19, 2006 (JP) P2006-252765

(51) Int. Cl. H01Q 9/04

(52) U.S. Cl. 343/791; 343/790

(57) ABSTRACT

A flexible printed board has a principal plane. A sleeve antenna pattern is formed on the principal plane of the flexible printed board.

The disclosure of Japanese Patent Application No. 2006-252765 filed Sep. 19, 2006 including specification, drawings and claims is incorporated herein by reference in its entirety.

### BACKGROUND

The present invention is related to an antenna device. More particularly, the present invention is related to improvements in a sleeve antenna.

As well known, in the field of mobile phones, the PDC system is employed in Japan and the GSM system is employed in Europe. In the case of digital mobile phones used in Europe, that is, in the case of the GSM system, fixed type helical antennas and built-in type antennas are mainly used as transmitting and receiving antennas (mobile phone terminal antennas). It is possible to consider that sleeve antennas are used as built-in type antennas.

As well known, the sleeve antenna is a coaxial type vertical antenna, which is a single vertical half wave length radiator. The sleeve antenna has no directivity in the horizontal direction. This sleeve antenna is used for eliminating a connection of a feeder line with the antenna.

FIG. 1 is a view showing an external appearance of a sleeve antenna 1. The sleeve antenna 1 includes a lower half portion 2 and an upper side radiating portion 3. The lower half portion 2 is a metallic sleeve. Inside the metallic sleeve, a feeder line 4 is concentrically arranged. For the feeder line 4, a coaxial cable or a semi-rigid cable is used. Length of the upper side radiating section 3 is ¼ wave length (λ/4). Length of the lower half portion 2 is also ¼ wave length (λ/4). The upper side radiating section 3 is connected to a central conductor of the feeder line 4.

Assume that a coaxial cable is used for the feeder line. In this case, the central conductor of the coaxial cable can be used as an upper side radiating portion 3 as it is. An external conductor of the coaxial cable is electrically connected to a metallic sleeve 2 by soldering. The metallic sleeve 2 consists of a pipe made of copper or brass. Accordingly, it is difficult to bend this metallic sleeve 2. In this case, it should be noted that the coaxial cable or the semi-rigid cable penetrates the inside of the metallic sleeve 2 as described above.

An antenna device is proposed which is capable of enhancing not only the horizontal polarization characteristic but also the vertical polarization characteristic (for example, refer to Patent Document 1). The Patent Document 1 discloses an embodiment in which a sleeve dipole antenna pattern is formed on a printed board. The sleeve dipole antenna disclosed in this Patent Document 1 includes: an L-shaped first wiring pattern formed on the printed board; an L-shaped second wiring pattern; an L-shaped ground pattern; and an L-shaped signal pattern. The second wiring pattern has a tip end portion which is separate from and opposed to a tip end portion of the first wiring pattern. The second wiring pattern is formed on the printed board substantially symmetrically with the first wiring pattern. The ground pattern has one end portion electrically connected to the tip end portion of the second wiring pattern. The ground pattern is formed on the printed board along the second wiring pattern, leaving an interval inside the second wiring pattern. The signal pattern has one end portion electrically connected to the tip end portion of the first wiring pattern. The signal pattern is formed on the printed board along the ground pattern, leaving an interval inside the ground pattern. At a tip end portion of the coaxial cable, a central conductor of the coaxial cable is connected to the other end portion of the signal pattern and an external conductor of the coaxial cable is connected to the other end portion of the ground pattern.

Further, a broad-band plane antenna using a micro-strip pattern is well known (for example, refer to Patent Document 2). The broad-band plane antenna disclosed in the Patent Document 2 includes: a plate-shaped dielectric board having a surface side and a back side; a radiating element made of feeding conductor foil formed on the surface side of this dielectric board; a passive conductor foil formed on the surface side of this dielectric board, leaving an interval on both sides of this radiating element; and a passive conductor foil formed on the back side of the dielectric board.

### Patent Document 1: Japanese Patent Publication No. 2006-50517A (FIG. 8)

### Patent Document 2: Japanese Patent Publication No. 2005-192172A

Since the sleeve antenna 1 shown in FIG. 1 includes a metallic sleeve 2 composed of a metallic pipe, the sleeve antenna 1 is not flexible. In the case of the antenna device disclosed in the Patent Document 1, since the antenna pattern is formed on a printed board, the antenna device is nor flexible, either. In the case of the plane antenna disclosed in the Patent Document 2, since the antenna uses a plate-shaped dielectric board, plane antenna is not flexible, either.

### SUMMARY

It is therefore an object of the invention to provide a flexible antenna device.

In order to achieve the above objects, according to an aspect of the invention, there is provided an antenna device comprising:

a flexible printed board, having a principal plane; and

a sleeve antenna pattern, formed on the principal plane of the flexible printed board.

The sleeve antenna pattern may include:
a first wiring pattern, having a first end portion and extending from the first end portion in a first direction on the principal plane;
a pair of second wiring patterns, having second end portions positioned in the vicinity of the first end portion, extending from the second end portions in a second direction opposite to the first direction on the principal plane, arranged in parallel with each other and separated from each other; and
a coaxial pattern, arranged between the second wiring patterns and extending in the second direction on the principal plane.

The coaxial pattern may include:
a signal pattern, having a third end portion electrically connected to the first end portion and extending from the third end portion in the second direction on the principal plane; and
a pair of ground patterns, having fourth end portions electrically connected to the second end portions, extending from the fourth end portions in the second direction on the principal plane, and arranged between the second wiring patterns while being separated from the first wiring pattern and the second wiring patterns.

The antenna device may further comprise a coaxial cable, having a central conductor and an external conductor, wherein:

the signal pattern may have a fifth end portion opposite to the third end portion;

the ground patterns may have sixth end portions opposite to the fourth end portions;

the central conductor may be electrically connected to the fifth end portion of the signal pattern at a tip end of the coaxial cable; and

the external conductor may be electrically connected to the sixth end portions of the ground patterns at the tip end of the coaxial cable.

The antenna device according to the aspect of the present invention uses the flexible printed board having the principal plane. On the principal plane of the printed board, the sleeve antenna pattern is formed. With this configuration, the antenna device is advantageous in that the flexibility is high.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective view showing a structure of a sleeve antenna;

FIG. 2 is a plan view showing an antenna device according to an embodiment of the present invention; and

FIG. 3 is a front view showing a coaxial cable used as a feeder line of the antenna device shown in FIG. 2.

### DETAILED DESCRIPTION OF THE EMBODIMENTS

Hereinafter, an embodiment of the invention will be described in detail with reference to the drawings.

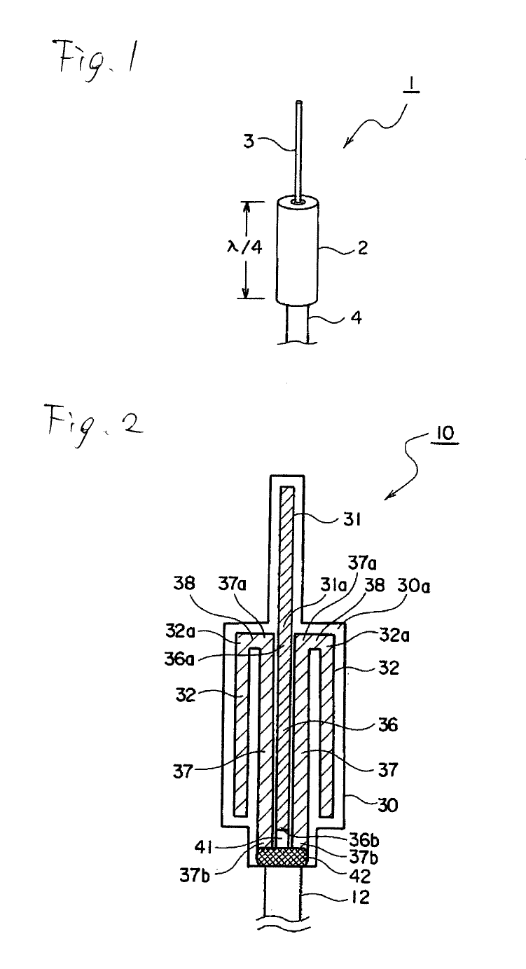

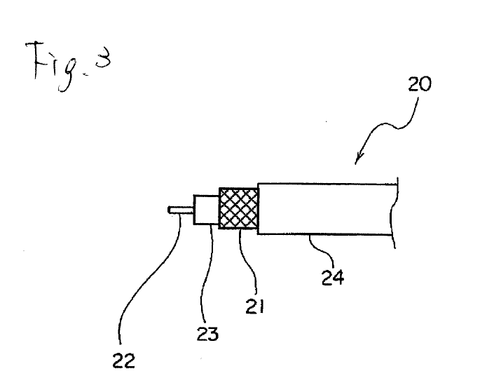

Referring to FIG. 2, an antenna device 10 of an embodiment of the present invention will be explained. FIG. 2 is a plan view of the antenna device 10. The antenna device 10 shown in FIG. 2 can be obtained when the sleeve antenna 1 shown in FIG. 1 is deformed as described later.

In the antenna device 10, a coaxial cable 20 shown in FIG. 3 is used as a feeder line 12. As shown in FIG. 3, the coaxial cable 20 is a coaxial electric signal transmitting medium including a cylindrical external conductor 21 and a central conductor 22 arranged at the center of the external conductor 21. The external conductor 21 and the central conductor 22 are insulated from each other by a cylindrical insulator 23. The external conductor 21 is covered with a sheath 24.

As shown in FIG. 2, the antenna device 10 includes a flexible printed board 30 having a principal plane 30a. On the principal plane 30a of this flexible printed board 30, a sleeve antenna pattern described later is formed.

The sleeve antenna pattern includes: a first wiring pattern 31 extending in a predetermined direction on the principal plane 30a of the flexible printed board 30; a pair of second wiring patterns 32; a signal pattern 36; and a pair of ground patterns 37. The first wiring pattern 31 has one end portion 31a and extends from the one end portion 31a in a predetermined direction. The pair of second wiring patterns 32 have one end portion 32a in the vicinity of the one end portion 31a of the first wiring pattern 31, extend from the one end portions 32a in a direction opposite to the predetermined direction (extending direction of the first wiring pattern 31) and are arranged in parallel with each other being separate from each other. The signal pattern 36 has one end portion 36a electrically connected to the one end portion 31a of the first wiring pattern 31. The signal pattern 36 extends from the one end portion 36a in the direction opposite to the predetermined direction (extending direction of the first wiring pattern 31). A pair of ground patterns 37 have one end portion 37a electrically connected to one end portions 32a of the pair of second wiring patterns 32 through a pair of connecting patterns 38. The pair of ground patterns 37 extend from the one end portions 37a in the direction opposite to the predetermined direction (extending direction of the first wiring pattern 31) and are arranged being separate from the signal pattern 36 and the pair of second wiring patterns 32 between the pair of second wiring patterns 32.

In this case, a combination of the signal pattern 36, the pair of ground patterns 37 and the pair of connecting patterns 38 acts as a coaxial pattern extending in the direction opposite to the predetermined direction and arranged between the pair of second wiring patterns 32.

Next, explanations will be made into a correspondence relationship between the antenna device 10 shown in FIG. 2 and the sleeve antenna 1 shown in FIG. 1. The first wiring pattern 31 acts as a radiating section 3. The second wiring pattern 32 fulfills a function of the metallic sleeve 2. The signal pattern 36 corresponds to a central conductor of the feeder line (coaxial cable) 4 inserted into the metallic sleeve 2. The pair of ground patterns 37 correspond to an external conductor of the feeder line (coaxial cable) 4 inserted into the metallic sleeve 2.

Accordingly, it can be understood that the antenna device shown in FIG. 2 acts as a sleeve antenna.

In this connection, concerning the feeder line (coaxial cable) 12, at the tip end portion, the central conductor 22 is electrically connected to the other end portion 36b of the signal pattern 36 by a solder 41. The external conductor 21 is electrically connected to the other end portions 37b of the pair of ground patterns 37 by a solder 42.

As described above, the antenna device 10 of the embodiment of the present invention includes: a flexible printed board 30 having a principal plane 30a; and a sleeve antenna pattern 31, 32, 36, 37, 38 formed on the principal plane 30a of the flexible printed board 30. Therefore, the antenna device 10 of the embodiment of the present invention is very flexible. Since only the sleeve antenna pattern is formed on the principal plane 30a of the flexible printed board 30, it is possible to provide the antenna device 10 of a simple structure.

The present invention has been explained above referring the preferable embodiment. However, it should be noted that the present invention is not limited to the above specific embodiment.

What is claimed is:

1. An antenna device comprising:
a flexible printed board, having a principal plane; and
a sleeve antenna pattern, formed on the principal plane of the flexible printed board.

2. The antenna device as set forth in claim 1, wherein the sleeve antenna pattern includes:
a first wiring pattern, having a first end portion and extending from the first end portion in a first direction on the principal plane;
a pair of second wiring patterns, having second end portions positioned in the vicinity of the first end portion, extending from the second end portions in a second direction opposite to the first direction on the principal plane, arranged in parallel with each other and separated from each other; and
a coaxial pattern, arranged between the second wiring patterns and extending in the second direction on the principal plane.

3. The antenna device as set forth in claim 2, wherein the coaxial pattern includes:
a signal pattern, having a third end portion electrically connected to the first end portion and extending from the third end portion in the second direction on the principal plane; and
a pair of ground patterns, having fourth end portions electrically connected to the second end portions, extending from the fourth end portions in the second direction on the principal plane, and arranged between the second wiring patterns while being separated from the first wiring pattern and the second wiring patterns.

4. The antenna device as set forth in claim 3, further comprising a coaxial cable, having a central conductor and an external conductor, wherein:
the signal pattern has a fifth end portion opposite to the third end portion;
the ground patterns have sixth end portions opposite to the fourth end portions;
the central conductor is electrically connected to the fifth end portion of the signal pattern at a tip end of the coaxial cable; and
the external conductor is electrically connected to the sixth end portions of the ground patterns at the tip end of the coaxial cable.
